(19) United States
(12) Patent Application Publication
(10) Pub. No.: US 2002/0099463 A1
(43) Pub. Date: Jul. 25, 2002

(54) Device for calculating overall equipment efficiency in machining factory

(76) Inventor: Mitsuo Sakaguchi, Kariya-shi (JP)

Correspondence Address: FLYNN, THIEL, BOUTELL & TANIS, P.C., 2026 Rambling Road, Kalamazoo, MI, 49008-1699, US

(21) Appl. No.: 10/008,677

(22) Filed: Dec. 7, 2001

(30) Foreign Application Priority Data
Dec. 11, 2000 (JP) 2000-375430

(51) Int. Cl. G06F 19/00

(52) U.S. Cl. 700/111; 702/182

(57) ABSTRACT

The present invention provides an index to make possible the evaluation of the production efficiencies of equipment in a machining factory on the same level, and provides a device for calculating that index. The device for calculating the overall equipment efficiency according to the present invention comprises: (1) a means for calculating a time utilization ratio, (2) a means for calculating a capacity utilization ratio, (3) a means for calculating a non-defective products ratio, and a means for calculating the overall equipment efficiency which is a product of items (1) through (3). All the factors causing reductions in the production efficiency of each of the facilities are collected and categorized, and the ratios (1) through (3) are indices reflecting categories thus obtained. The overall equipment efficiency is an index whereby those are comprehensively evaluated and the equipment can be compared on the same level.

### BACKGROUND OF THE INVENTION

1. Field of the Invention

The present invention relates to a device for correctly calculating the current production efficiency of equipment or facilities in order to further improve the production efficiency in a machining factory.

2. Description of the Related Art

In manufacturing work in a factory such as a machining factory, it is mostly the case that manufacturing one product requires a plurality of processes. In other words, a plurality of facilities are operated in order to manufacture one product. Conventionally, in order to reduce manufacturing costs for that product and in order to improve production efficiency, the utilization rates of the equipment are evaluated periodically using independent indices, determined to be important by skilled engineers based on their experience involved in the operation of the equipment. For example, in a process for cutting metal materials to a specific form for which it is necessary to replace the cutting blades frequently, the time required to change the parts is determined to have the most serious influence on the utilization rate of the equipment. In that case, the time necessary for replacing blades is measured in relation to the time that the cutting machine is operating, and the ratio of those times becomes the index that best reflects the utilization situation of the equipment. In a process wherein parts do not need to be exchanged, but defectives are often produced because of the performance of the machine, the number of non-defectives, exclusive of the number of defectives, is measured with respect to the number of items produced and the non-defective products ratio is found; this becomes the index that best reflects the production efficiency of the equipment. In this way, individual indices determined to be important for each of the facilities are used and automation is carried out.

However, because the elements affecting the production efficiency are different for various equipment, an independent index is used for each of the facilities. For this reason, it is difficult to compare the production efficiencies of the facilities on the same basis. Also, even if the same index is used for different facilities, it is difficult to determine which of the facility has a good or bad efficiency overall, because such index does not necessarily reflect the production efficiencies of the respective facilities in the same extent. It is effective to improve a facility having the most serious problems at first, whatever the problems are, from among the equipment operated in the manufacture of a product. In other words, it is necessary to discover the facility that is a bottleneck to improve production efficiency in the plurality of machinery processing processes. The inventor made note of this point and have proposed the following overall equipment efficiency as an index for calculating the overall production efficiency of each of the facilities, and which accurately reflects the production efficiency of each facility and can be compared among the equipment.

However, in calculating the overall equipment efficiency for the equipment, it is necessary to carry out complicated measurements corresponding to each of facilities. For example, for one facility, it is necessary to measure periodically detailed machine stoppages and idling time, operating time of the machine, and number of non-defectives, and making the calculation using those data. For this reason, particularly in the case where there is a large number of facilities and an item passes through complex processing, time and staff are necessary just in order to find the production efficiency and this is contrary to the original object of improving production efficiency in the factory. Furthermore, as the quantity of that collected data grow, statistical analysis for trends in the history and equipment deterioration becomes difficult. Currently, it is often the case that the number of facilities in a machining factory necessary to complete a product is 20 to 3000 and the amount of data for calculating the overall equipment efficiency are expanding. Consequently, in order to improve the production efficiency for the entire factory, a device to calculate continuously and manage the production efficiency using the index is required and it is desirable to advance the automation of the factory further.

### SUMMARY OF THE INVENTION

Corresponding to the above-mentioned requirements, the present invention provides a device for calculating the overall equipment efficiency for evaluating the production efficiency of each facility or equipment in a machining factory and comprising: a means for calculating a time utilization ratio; a means for calculating a capacity utilization ratio; a means for calculating in a non-defective products ratio; and a means for calculating a product of the above-mentioned time utilization ratio, the above-mentioned capacity utilization ratio, and the above-mentioned non-defective products ratio.

As a result of comparing and examining the current problems of manufacturing factories in various types of work, the inventors found an index for evaluating the production efficiencies of each of a plurality of facilities on the same basis and that could be applied to any type of factory, and proposed a device for calculating the index reflecting the production efficiency. That index is the overall equipment efficiency and is defined as follows.

$$( Overall equipment efficiency ) ≡ ( Time utilization ratio ) \times ( Capacity utilization ratio ) \times ( Non \text{-} defective products ratio )$$

The time utilization ratio, capacity utilization ratio, and non-defective products ratio are numerical values derived by collecting all of the various factors expected to reduce the production efficiency of the equipment, classifying those into seven categories, and the values are acquired and calculated in accordance with the categories. The definitions of the time utilization ratio, capacity utilization ratio, and non-defective products ratio are explained below. FIG. 1 shows an explanatory diagram showing how to calculate the time utilization ratio, capacity utilization ratio, and non-defective products ratio in order to obtain the overall equipment efficiency. The upper portion of FIG. 1 shows the concept of the time utilization ratio, factors reducing the production efficiency relating to the time utilization ratio, and an equation, including an example. The middle and lower portions of FIG. 1 show the concepts, factors reducing production efficiency, and equations for the capacity utilization ratio and non-defective products ratio respectively, like for the time utilization ratio.

(1) Time Utilization Ratio

The time calculated by subtracting planned stoppage times, such as lunch breaks, from one day's operating time for the equipment is found. This is the loading time. The time utilization ratio is calculated by subtracting time in which the equipment is stopped because of the following factors 1 through 4 (stoppage time) from the loading time. The stoppage times resulting from those factors are as follows.

1. Failure: The time in which equipment is stopped because of a failure of the equipment.

2. Setup and adjustment: The time in which equipment is stopped because of setup for a manufacturing process or adjustment of the equipment.

3. Parts replacement: The time in which equipment is stopped to replace parts such as cutting tools installed in the equipment.

4. Startup: The time necessary for startup until equipment starts operating. Consequently, the time utilization ratio is calculated with the following formula.

$$( Time utilization ratio ( \% ) ) = ( Loading ti me - stoppage time ) / ( Loading time ) \times 100$$

When calculating the overall equipment efficiency, use the value that is not multiplied by 100.

(2) Capacity Utilization Ratio

Further reductions in production efficiency due to the performance of the equipment are considered with respect to the time consisting of the stoppage time subtracted from the loading time (utilization time). Factors 5 and 6 derived from the performance of the equipment are classified as follows.

5. Idling and minor stoppage: The machines of equipment are idling or the equipment is operating but has short-term stoppages.

6. Speed reductions: The mechanical speed of the operating equipment drops.

The production efficiency reduced by 5 and 6 is calculated as the capacity utilization ratio as follows using a design standard time, necessary for manufacturing one item with the equipment (standard cycle time).

$$( Capacity utilization ratio ( \% ) ) = ( ( Standard cycle time ) \times ( Number of processed items ) ) / ( Utilization time ) \times 100$$

When calculating the overall equipment efficiency, use the value that is not multiplied by 100.

(3) Non-Defective Products Ratio

The factor 7 that reduces the production efficiency of the equipment is the production of defectives. Consequently, the production efficiency resulting from the factor 7 is calculated as follows as the non-defective products ratio.

$$( Non \text{-} defective products ratio ( \% ) ) = ( ( Number of processed items ) - ( Number of defectives ) ) / ( Number of processed items ) \times 100$$

When calculating the overall equipment efficiency, use the value that is not multiplied by 100.

The factors predicted to bring about reduced production efficiency in the various equipment of a machining factory are all included in the above-mentioned items 1 through 7. Moreover, in order to calculate the overall equipment efficiency for each of the facilities, it is necessary to calculate the above-mentioned ratios (1) through (3) for each of the facilities. Consequently, the overall equipment efficiency for each facility is attained as an overall index reflecting all of the factors 1 through 7, regardless of which is the principal factor. In the case where an item must pass through a series of processes used in a production line until the final product is completed, the apparatus or the facility that is the bottleneck can be easily determined if the overall equipment efficiency is calculated for each apparatus of the equipment or each of the facilities used in each process. Furthermore, in the case where there is a sudden drop in the overall equipment efficiency for any facility, it becomes possible to discover the malfunctioning equipment quickly and take countermeasures through examination and analysis of whether the drop occurred because of one of the items 1 through 7.

The time utilization ratio is calculated by inputting to a computer, such as a personal computer, the loading time as existing data and the measured stoppage time as measured data during operation for each of the facilities in the factory. These input data and time utilization ratio are preferably made into a database, with the stoppage time classified by items 1 through 4 for the input data, and the tendency over time accumulated. In this way, for example, if the situation arises wherein the stoppage time due to failures of item 1 gradually increases and the overall equipment efficiency is reduced, it becomes easy to take countermeasures, for example, the equipment may be adjusted or repaired at some period.

In order to acquire the capacity utilization ratio, the standard cycle time according to the design standard, as existing data, and the measured number of processed items, as data measured during operation, are input to a computer such as a personal computer for each of the facilities in the factory. The capacity utilization ratio is calculated using these input data and the utilization time calculated with data input when calculating the time utilization ratio (loading time less stoppage time). These input data and capacity utilization ratio are preferably made into a database like the time utilization ratio and the tendency over time accumulated.

The good product ratio is calculated by measuring the quantity of processed items and quantity of defectives for each of the facilities in the factory, inputting these data to a computer such as a personal computer and calculating. For these input data and non-defective products ratio as well, it is preferable that a record be made every day and the tendency over time accumulated, as is done for the time utilization ratio and capacity utilization ratio.

The overall equipment efficiency is calculated for each of the facilities with a computer such as a personal computer using the data calculated for the time utilization ratio, capacity utilization ratio, and non-defective products ratio as discussed above. So long as it comprises an input function, a memory device, a calculation processing function, and a display device, the device for calculating the overall equipment efficiency relating to the present invention may be a single computer such as a personal computer used when calculating the time utilization ratio, capacity utilization ratio, non-defective products ratio, and the overall equipment efficiency, or a plurality of computers connected over a network. A plurality of input devices and display devices may also be provided for a single calculation-processing unit. It is also possible to automate the measurements of time and quantity for each process and input the data from those measurement devices to a personal computer or the like through an interface board or the like. It is preferable that the measurement data be acquired automatically in order to save time.

By use of the device for calculating the overall equipment efficiency relating to the present invention, it becomes possible to calculate the production efficiency for each of the facilities quickly and easily and also to collect and manage those production efficiencies in a single location. Consequently, it can achieve a previously impossible operation wherein the facility that was a bottleneck can be found every day at the end of operations for each production line, and countermeasures taken every day. If a computer program is used so as to calculate the overall equipment efficiency periodically and display the apparatus having the lowest efficiency, it also becomes possible to discover bottlenecks in connected processing machines automatically. In other words, further automation of the factory is realized with the device according to the present invention. In addition, a continuously high level of production efficiency is maintained for the equipment. It also decreases costs by reducing staff and time.

Furthermore, the device for calculating the overall equipment efficiency relating to the present invention can also calculate deviation from target values, based on a production plan, for the overall equipment efficiency. Such device for calculating the overall equipment efficiency is particularly useful when manufacturing many different types of processed goods using the same equipment. The daily production goal is set with the shipping plan for each type of items. The target for overall equipment efficiency is established according to this production target. For example, the time from when a work (material or processed item from a preceding facility) is input until the processed item comes out, meaning the standard cycle time for that work, is one minute, and the plan is to produce 100 processed items. The time frame for this plan is an idealized time plan established without failure of the equipment, other stoppages, reduced performance of the equipment, or defectives. In other words, the loading time is 1 minute×100 items=100 minutes; and the time utilization ratio is 100%, the capacity utilization ratio is 100% without performance reductions, and the non-defective products ratio is 100% without any defectives. The overall equipment efficiency in this case becomes 100%. When 100 items are actually processed, however, measurement results show that it took 200 minutes. At this time, the overall equipment efficiency is 50%. In this case, in order to determine the cause thereof, it can be automatically and instantly found for each of the facilities whether this is due to a stoppage of the equipment causing a reduction in the pre-established target time utilization ratio, a reduced equipment performance such as an increase in the standard cycle time reducing the target capacity utilization ratio, or the output of defectives reducing the target non-defective products ratio. In general cases, in one day's operations, a composite production plan for processing a plurality of lots (indicating the types of works) is established and carried out. In this case, for example, it is instantly revealed which lot was delayed and caused failure of the production plan. Moreover, in the case of finding the overall equipment efficiency per day for a composite production, this is expressed as follows.

$$( Sum of overall equipment efficiencies per lot ) / ( The number of lots )$$

In the case of establishing the target values according to the production plan in the device for calculating the overall equipment efficiency, the production plan, such as type of work and number to be processed may be input in advance to the device, the target values may be calculated, and a comparison may be made with the overall equipment efficiency based on measured data. By acquiring the deviations from the target values in this way, the device can clearly determine whether the processed items were manufactured ideally or whether the production efficiency dropped. In other words, the target value provides a clear, quantitative standard for determination. Consequently, the device can transmit an indication of whether to take countermeasures, such as inspection or repair of the equipment, to an operator automatically according to this determination standard. This type of determination may be made at the end of one day's operations, but can also be made automatically at the end of the production of each lot and a quick response can be made in the case where a problem occurs in the equipment.

### BRIEF DESCRIPTION OF THE DRAWINGS

FIG. 1 is a drawing to explain the overall equipment efficiency; and

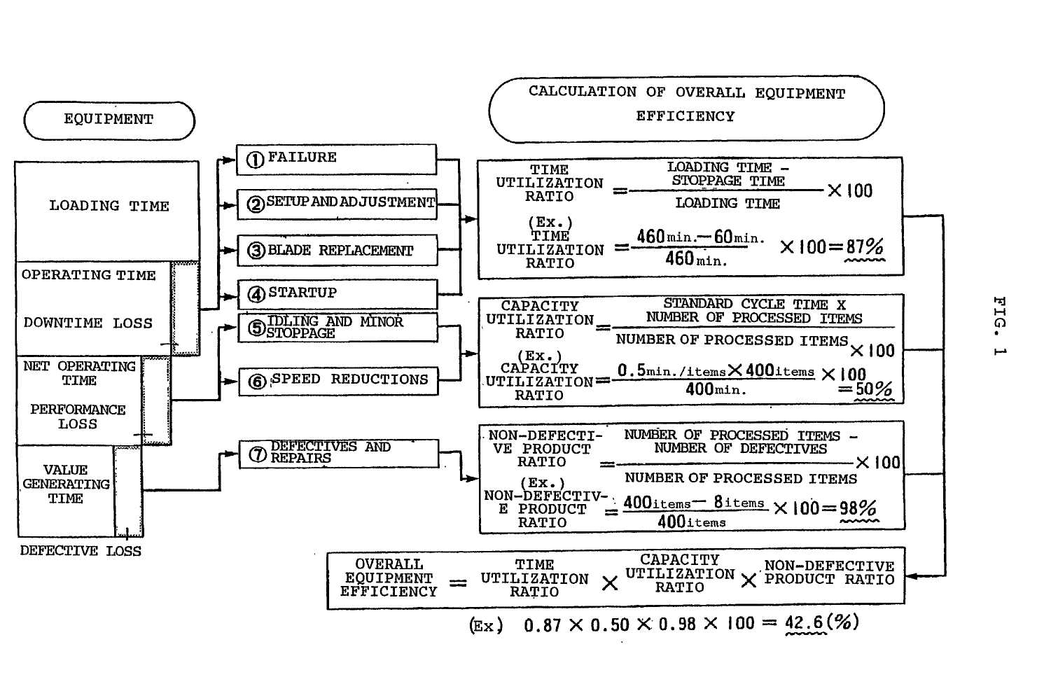

FIG. 2 is a drawing showing an example of the data collected in order to calculate the overall equipment efficiency.

### DETAILED DESCRIPTION OF THE PREFERRED EMBODIMENTS

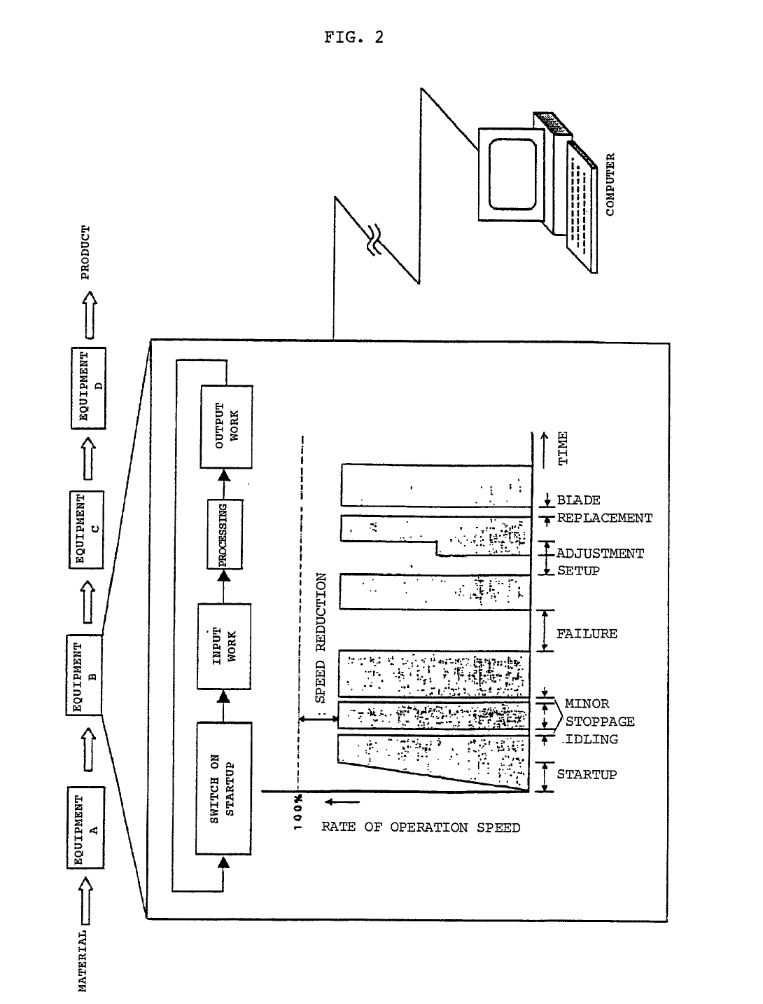

The preferred embodiments of the present invention are explained below using the example shown in FIG. 2.

The white arrows in the upper portion of FIG. 2 show the flow in a production line in a machining factory from when material is introduced, and that material is successively processed through the four types of equipment A, B, C and D, until a finished product is send out. The square in the center of FIG. 2 shows the data collected for the utilization situation of the equipment B, from among the four, and for calculating the overall equipment efficiency. The solid arrows in the upper portion in the box show the utilization situation of the equipment B. After the switch is turned and startup, the work (indicating the first processed item sent from the equipment A) is thrown into the equipment B. The work is processed by the equipment B and sent out. If the processes for machinery processing and transport need only a short time from when the work is input, these processes are repeated in the equipment's cycle time. If the switch of the equipment B is turned off after this series of operations, the work cycle returns to the stage at which the switch is turned on.

The graphs drawn in the box show measured data collected for the equipment B; the horizontal axis shows the working time and the vertical axis shows the equipment operation rate of speed (the converted value of the equipment operation speed on condition that the ideal operation speed is 100). Although the capacity utilization ratio is calculated accurately using the number of processed items, the area of the graph can be regarded as a product of the time utilization ratio and the capacity utilization ratio. In order to acquire this type of data, it is preferable to store measured data that directly reflect the equipment operation rate of speed, such as measuring the current load flowing into the equipment's machinery or the turnover rate of the machine, automatically in the computer. The time while the equipment is stopped may have the type of cause input as supplementary data; for example, the type of cause may be established in advance corresponding to the length of the time, such as classifying a certain time or below as a minor stoppage or idling. Although not shown, the process for inspecting the output products and measuring the quantity of defectives is performed at the end of the equipment B. In this way, with measuring the operation speed, measuring the time in which the equipment is stopped and determination of the cause thereof, and measuring the quantity of processed items and the quantity of defectives, the overall equipment efficiency of the equipment B is calculated.

With the use of the device for calculating the overall equipment efficiency relating to the present invention, it is possible to discover easily the process which is the bottleneck up to the completion of a product in the case of using a plurality of facilities at a machining factory. By first improving the equipment used in this bottleneck process, it becomes possible to improve the production efficiency for that product most effectively. Also, by accumulating the measured data and calculated data used for calculating the overall equipment efficiency, analysis of the causal factors can be done easily using this accumulation of data, and a response can be made quickly.

What is claimed is:

1. A device for calculating the overall equipment efficiency for evaluating the production efficiency of equipment in a machining factory and comprising:
a means for calculating a time utilization ratio;
a means for calculating a capacity utilization ratio;
a means for calculating a non-defective products ratio; and
a means for calculating a product of said time utilization ratio, said capacity utilization ratio, and said non-defective products ratio.

2. The device for calculating the overall equipment efficiency according to claim 1, further comprising a means for calculating a deviation from a target value according to a production plan, with respect to the product of said time utilization ratio, said capacity utilization ratio, and said non-defective products ratio.
